(19) United States
(12) Patent Application Publication
(10) Pub. No.: US 2013/0130737 A1
(43) Pub. Date: May 23, 2013

(54) CONTROL STATION, REMOTE STATION, COMMUNICATION SYSTEM AND COMMUNICATION METHOD

(71) Applicant: FUJITSU LIMITED, Kawasaki-shi (JP)

(72) Inventor: Takaharu Kobayashi, Yamato (JP)

(73) Assignee: FUJITSU LIMITED, Kawasaki-shi (JP)

(21) Appl. No.: 13/625,967

(22) Filed: Sep. 25, 2012

(30) Foreign Application Priority Data
Nov. 22, 2011 (JP) 2011-255384

(51) Int. Cl. H04W 52/04

(52) U.S. Cl. 455/522

(57) ABSTRACT

A control station connected with a plurality of remote stations, the control station being configured to communicate with a terminal via the plural remote stations, includes a memory, and a processor that, when executing a procedure stored in the memory, upon each of the plural remote stations transmitting same data to the terminal according to a transmission power pattern in which transmission power varies in a direction of frequencies or time, receives a group of data of received signal quality that is based on power received by the terminal at frequency or time intervals, and calculates a path loss value for each of the plural remote stations on the basis of a group of transmission power levels at frequency or time intervals for each of the plural remote stations and the group of data of received signal quality received from the terminal.

### CROSS-REFERENCE TO RELATED APPLICATION

This application is based upon and claims the benefit of priority of the prior Japanese Patent Application No. 2011-255384, filed on Nov. 22, 2011, the entire contents of which are incorporated herein by reference.

### FIELD

The embodiments discussed herein are related to a control station, a remote station, a communication system and a communication method.

### BACKGROUND

A distributed antenna system has been studied in which a wireless base station is divided into a control station and a plurality of remote stations. The remote stations are each formed of a wireless processor including an antenna and separately provided from one another in the distributed antenna system. The distributed antenna system including the control station and the plural remote stations forms a cell. The control station transmits a same signal to the respective remote stations and the remote stations each transmit a wireless signal to a terminal, so that a distance over which a radio wave is propagated may be shortened. Further, signals coming from the plural remote stations are combined on the terminal so that a gain is enhanced and received signal quality may be resultantly enhanced.

### SUMMARY

According to an aspect of the invention, a control station connected with a plurality of remote stations, the control station being configured to communicate with a terminal via the plural remote stations, includes a memory, and a processor that, when executing a procedure stored in the memory, upon each of the plural remote stations transmitting same data to the terminal according to a transmission power pattern in which transmission power varies in a direction of frequencies or time, receives a group of data of received signal quality that is based on power received by the terminal at frequency or time intervals, and calculates a path loss value for each of the plural remote stations on the basis of a group of transmission power levels at frequency or time intervals for each of the plural remote stations and the group of data of received signal quality received from the terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an outline of a system of the related art;

FIG. 2 illustrates an exemplary system configuration of a first embodiment;

FIG. 3 illustrates exemplary functional blocks of a control station of the first embodiment;

FIG. 4 illustrates exemplary transmission power levels of respective remote stations in respective frequency ranges that the remote stations are notified of;

FIG. 5 illustrates exemplary functional blocks of the remote station of the first embodiment;

FIG. 6 illustrates exemplary functional blocks of a terminal of the first embodiment;

FIG. 7 illustrates an exemplary hardware configuration of the control station;

FIG. 8 illustrates an exemplary hardware configuration of the remote station;

FIG. 9 illustrates an exemplary hardware configuration of the terminal;

FIG. 10 illustrates an exemplary operational sequence of the system of the first embodiment;

FIG. 11 illustrates an exemplary operational flow for determining the transmission power level by a transmission power determining section in the control station of the first embodiment;

FIG. 12 illustrates exemplary functional blocks of a control station of a second embodiment;

FIG. 13 illustrates exemplary transmission power levels of respective remote stations on respective occasions when the power is changed that the remote stations are each notified of;

FIG. 14 illustrates exemplary functional blocks of the remote station of the second embodiment;

FIG. 15 illustrates exemplary functional blocks of a terminal of the second embodiment;

FIG. 16 illustrates an exemplary operational sequence (1) of the system of the second embodiment;

FIG. 17 illustrates an exemplary operational sequence (2) of the system of the second embodiment;

FIG. 18 illustrates an exemplary operational flow for determining the transmission power level by a transmission power determining section in the control station of the second embodiment; and

FIG. 19 illustrates exemplary transmission power levels of respective remote stations on respective occasions when the power is changed in respective frequency ranges that the remote stations are each notified of.

### DESCRIPTION OF EMBODIMENTS

Hereinafter, embodiments will be explained with reference to the drawings.

While inventing the present embodiments, observations were made regarding a related art. Such observations include the following, for example.

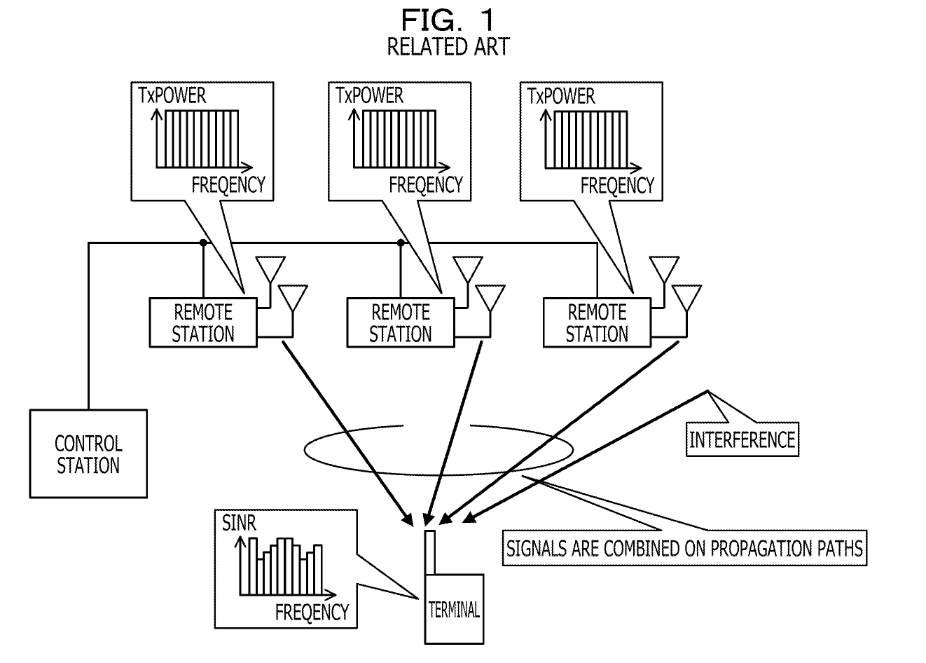

FIG. 1 illustrates an outline of a system of the related art. The terminal receives signals coming from the respective remote stations and combined on the propagation paths. The terminal performs communication without detecting that the signals are transmitted from the plural remote stations.

It is difficult for the terminal to separate the received signal into signal components from the respective remote stations. It is difficult for the terminal to know an amount of attenuation caused by the propagation (also referred to as a path loss value, hereafter) between each of the remote stations and the terminal separately for every remote station.

A method for estimating an amount of distance-based attenuation between each of terminals and each of remote stations based on a received signal on the uplink has been proposed to estimate a path loss value between each of the remote stations and the terminal. In order to measure the amount of distance-based attenuation by using a received signal on the uplink, however, one control station is connected to multiple remote stations so as to form a star-shaped network at least on the uplink, and the control station separates users for every link so as to measure the amount of distance-based attenuation. Otherwise, each remote station separates users so as to measure the amount of distance-based attenuation for each of the users. According to these methods, the process for separating users for each of the links or separating users by each of the remote stations is complicated and thus has a problem from a viewpoint of the cost, etc. Another method is to add an individual identification signal on the downlink at the remote station, and to separate the received signal at the terminal into signal components coming from the respective remote stations for measurement and feedback. According to the latter method, however, an identification signal is transmitted and received by the remote station and the terminal, and the terminal performs separation of the remote stations and feedback of the path loss value of each of the remote stations. Such a method has a problem from the viewpoints of the complicated process at the terminal and size of control data.

According to the following embodiments, a method for estimating a path loss in a simplified manner may be provided.

Although the embodiments will be explained in an assumption that the Long Term Evolution (LTE) is employed as a communication system, the communication system applied to the embodiments explained below is not limited to the LTE. The embodiments explained below may be applied to other communication systems.

### First Embodiment

### Exemplary Configuration

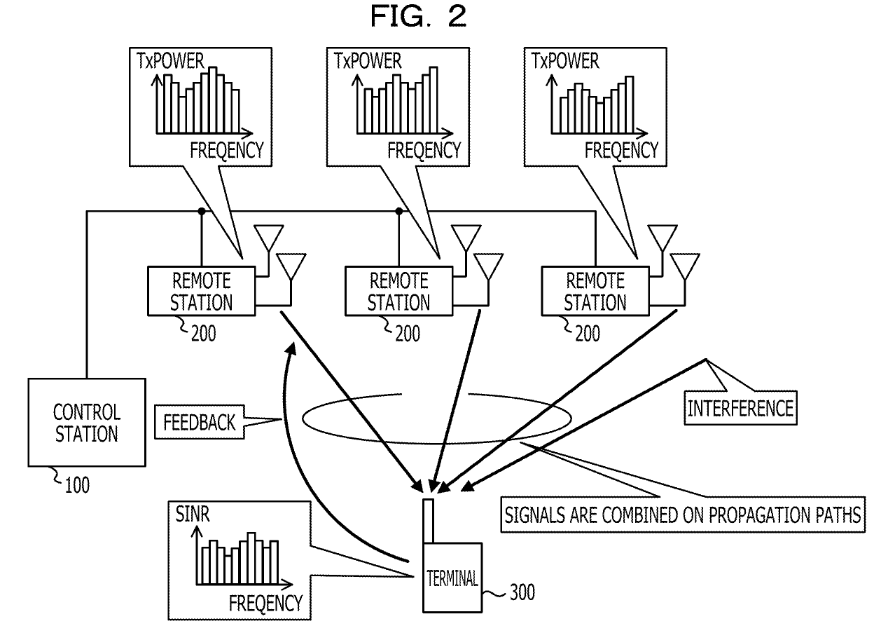

FIG. 2 illustrates an exemplary system configuration of the embodiment. The system of the embodiment includes a control station 100, a plurality of remote stations 200 and terminals 300. Although three remote stations 200 are exemplarily illustrated in FIG. 2, the number of the remote stations is not limited to three. Although one remote station 300 is exemplarily illustrated in FIG. 2, the number of the terminals 300 is not limited to one. The remote stations 200 are each connected to the control station 100. The remote stations 200 are each connected to the control station 100 via a communication line formed by an optical fiber, etc. The terminal 300 may receive a signal from each of the remote stations 200. Further, the terminal 300 may receive a signal (interference signal) from other origins than the remote stations 200. The terminal 300 communicates with the control station 100 via one or more remote stations 200.

The system of the embodiment is to estimate a path loss value between each of the remote stations 200 and the terminal 300. The control station 100 of the embodiment changes transmission power of a signal output from the remote station 200 in a direction of frequencies.

The control station 100 modulates upper rank data and carries out subcarrier-mapping of In-phase/Quadrature (I/Q) signals, and transmits a resultant signal to the remote station 200 on the downlink. The remote station 200 carries out an Inverse Fast Fourier Transform (IFFT) operation on the received signal and adds a Cyclic Prefix (CP) to the received signal so as to convert the received signal into an OFDM signal, and transmits the OFDM signal. The term upper rank, e.g., means an upper layer. The upper layer of the embodiment is omitted to be explained, though.

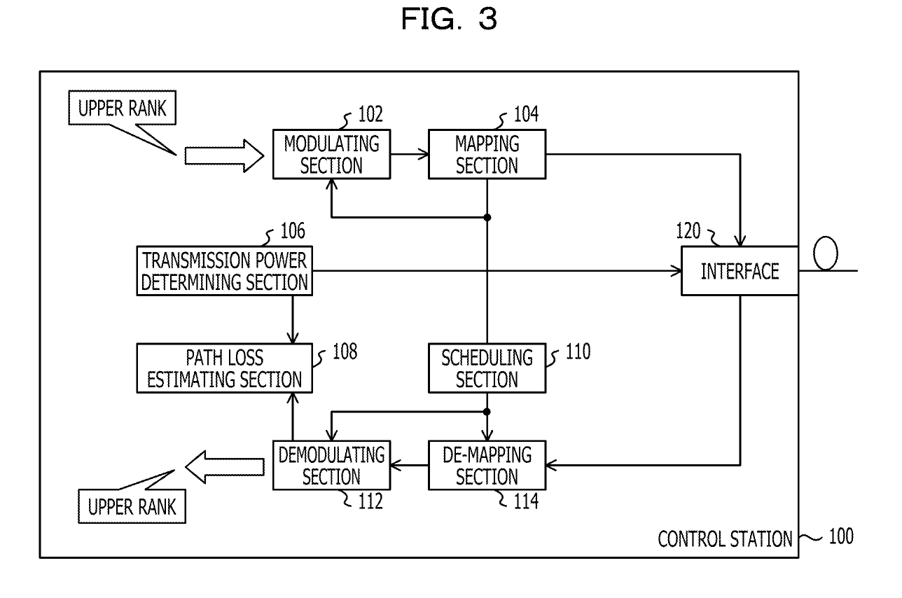

FIG. 3 illustrates exemplary functional blocks in the control station. The control station 100 includes a modulating section 102, a mapping section 104, a transmission power determining section 106, a path loss estimating section 108, a scheduling section 110, a demodulating section 112 and a de-mapping section 114.

The modulating section 102 carries out a specific modulation process on a signal received from the upper rank. The modulating section 102 provides the mapping section 104 with the modulation-processed signal. The signal received from the upper rank includes a reference signal. The reference signal is, e.g., a sequence of signals for estimating a channel characteristic between the remote station and the terminal.

The mapping section 104 maps the signal modulated by the modulating section 102 onto subcarriers (frequency ranges) on the basis of a schedule (data of frequency band allotments) that the mapping section 104 is notified of by the scheduling section 110. The signal processed by the mapping section 104 is output to the remote station 200 via an interface 120.

The transmission power determining section 106 determines a transmission power level for each of the remote stations 200 in each of frequency ranges (transmission power pattern). The transmission power determining section 106 provides the remote station 200, via the interface 120, with the transmission power level determined for each of the remote stations 200 in each of the frequency ranges. The transmission power level for each of the remote stations 200 in each of the frequency ranges is provided, e.g., as notification data. How to calculate the transmission power level for each of the remote stations 200 in each of the frequency ranges will be described later in detail.

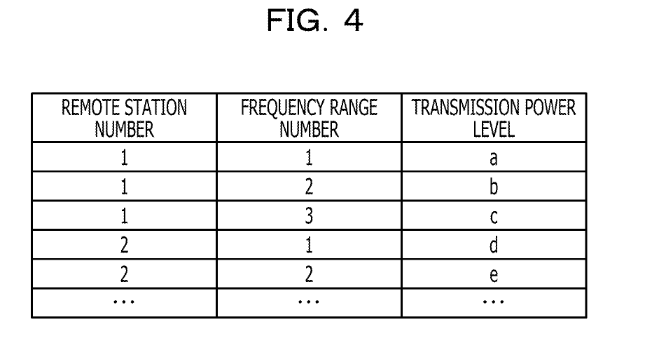

FIG. 4 illustrates exemplary transmission power levels of the respective remote stations in the respective frequency ranges that the remote stations are notified of. The transmission power determining section 106 determines a transmission power level for each of the remote stations in each of the frequency ranges as illustrated in FIG. 4, and notifies each of the remote stations 200 of what is determined. The table illustrated in FIG. 4 corresponds to a matrix P described later.

The path loss estimating section 108 estimates a path loss value between each of the remote stations and the terminal by using the transmission power level in each of the frequency ranges that the remote stations 200 are each notified of and received signal quality in each of the frequency ranges on the terminal 300. The path loss estimating section 108 receives the transmission power level in each of the frequency ranges that the remote stations 200 are each notified of by the transmission power determining section 106. Further, the path loss estimating section 108 receives received signal quality (data of received signal quality) in each of the frequency ranges on the terminal 300 from the demodulating section 112.

The scheduling section 110 notifies the mapping section 104, the de-mapping section 114, etc., of the data of frequency band allotments. The data of frequency band allotments indicates allotments of frequency band, time, etc., to be used for radio signals exchanged between the remote stations and the terminal.

The demodulating section 112 demodulates and processes a signal converted by the de-mapping section 114. The demodulating section 112 extracts feedback data, etc., given by the terminal 300 and provides the path loss estimating section 108 with what is extracted. The demodulating section 112 provides the upper rank with the received signal. The term upper rank, e.g., means an upper layer.

The de-mapping section 114 converts a signal received from the remote station 200 via the interface 120 into a signal before being mapped on the basis of a schedule (data of frequency band allotments) that the de-mapping section 114 is notified of by the scheduling section 110.

The interface 120 is connected to an external communication line, outputs a signal inside the control station 100 to the external communication line, and receives a signal from the external communication line. The interface 120 is connected to the respective remote stations 200 via communication lines formed by optical fibers, etc.

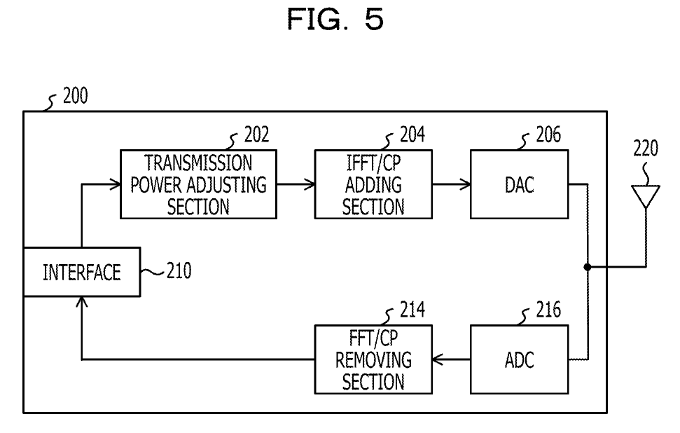

FIG. 5 illustrates exemplary functional blocks in the remote station. The remote station 200 includes a transmission power adjusting section 202, an IFFT/CP adding section 204, a DAC 206, an interface 210, an FFT/CP removing section 214, an ADC 216 and an antenna 220.

The remote stations 200 each transmit and receive radio signals to and from the terminal 300 by using a plurality of frequency ranges. The remote stations 200 may each have a unique identification number (remote station number).

The transmission power adjusting section 202 extracts a transmission power level of the remote station in each of the frequency ranges from the transmission power levels of the respective remote stations 200 in the respective frequency ranges that the remote stations are each notified of by the control station 100. The transmission power adjusting section 202 adjusts a transmission power level of a transmission signal in each of the frequency ranges on the basis of the transmission power level in each of the frequency ranges.

The inverse fast Fourier transform (IFFT)/Cyclic Prefix (CP) adding section 204 carries out an inverse fast Fourier transform (IFFT) operation on the signal mapped by the mapping section 104, so as to convert the signal in the frequency domain into a signal in the time domain. Further, the IFFT/CP adding section 204 adds a Cyclic Prefix (CP) to the signal in the time domain that the signal in the frequency domain is converted into.

The digital to analog converter (DAC) 206 converts the data signal (digital signal) processed by the IFFT/CP adding section 204 into an analog signal. Then, the DAC 206 provides the antenna 220 with the analog signal that the data signal is converted into.

The interface 210 is connected to an external communication line, outputs a signal inside the remote station 200 to the external communication line and receives a signal from the external communication line. The interface 210 is connected to the control station 100 via a communication line formed by an optical fiber, etc.

The analog to digital converter (ADC) 216 converts a radio signal received by the antenna 220 into a digital signal. The ADC 216 provides the FFT/CP removing section 214 with the digital signal (data signal) that the radio signal is converted into.

The Fast Fourier Transform (FFT)/Cyclic Prefix (CP) removing section 214 removes a CP from the data signal after being converted by the ADC 216. Further, the FFT/CP removing section 214 carries out a fast Fourier transform (FFT) operation on the data signal remaining after the CP is removed so as to convert the signal in the time domain into a signal in the frequency domain.

The antenna 220 transmits and receives a radio signal to and from the terminal 300.

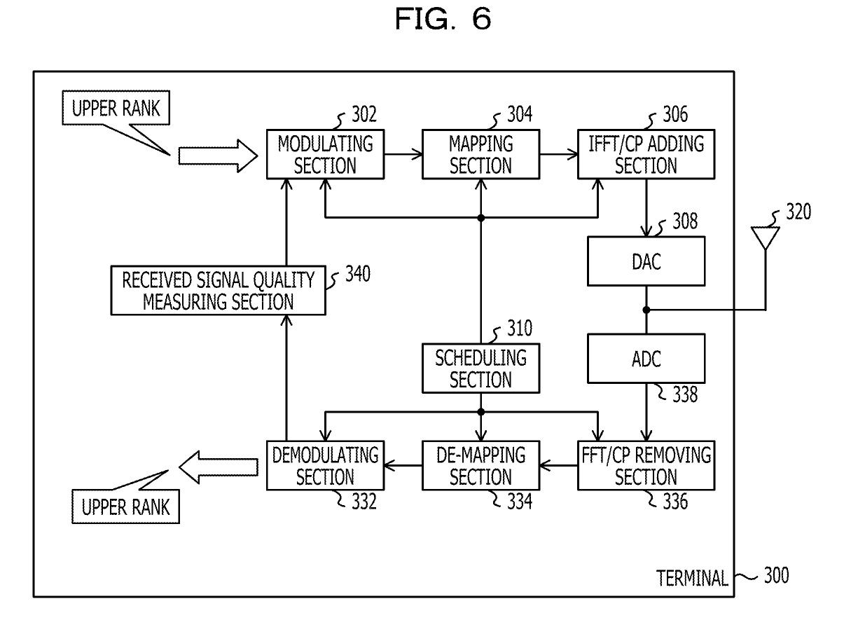

FIG. 6 illustrates exemplary functional blocks in the terminal. The terminal 300 includes a modulating section 302, a mapping section 304, an IFFT/CP adding section 306, a DAC 308, a scheduling section 310, an antenna 320, a demodulating section 332, a de-mapping section 334, an FFT/CP removing section 336, an ADC 338 and a received signal quality measuring section 340.

The terminal 300 measures received signal quality in each of frequency ranges in accordance with a received power level of a reference signal that the control station 100 transmits via the remote station 200 and an interference power level coming from another cell. The terminal 300 transmits a sub-band Channel Quality Indicator (CQI) carried by a control signal on the uplink to the control station 100 based on resultantly measured received signal quality. The sub-band CQI is a signal indicating quantized received signal quality in each of the frequency ranges. The sub-band CQI is a kind of feedback data. The terminal 300 periodically transmits the sub-band CQI to the control station 100. The sub-band CQI indicates received signal quality in each of the frequency ranges. The received signal quality is, e.g., strength of a received reference signal.

Further, the terminal 300 periodically transmits a reference signal received power (RSRP) level and an RSRQ level which is a ratio of the RSRP to a total received power level to the control station 100 via the remote station 200. The RSRP and the RSRQ levels are included in the feedback data.

The modulating section 302 receives a signal from an upper rank. The modulating section 302 receives feedback data from the received signal quality measuring section 340. The modulating section 302 performs a specific data processing operation for modulation on the received signal. The modulating section 302 provides the mapping section 304 with the signal processed for modulation. The term upper rank, e.g., means an upper layer.

The mapping section 304 maps the signal modulated by the modulating section 302 onto subcarriers (frequency ranges) on the basis of a schedule (data of frequency band allotments) that the mapping section 304 is notified of by the scheduling section 310. The signal processed by the mapping section 304 is provided to the IFFT/CP adding section 306.

The IFFT/CP adding section 306 performs an IFFT operation on the signal mapped by the mapping section 304 and converts the signal in the frequency domain into a signal in the time domain. Further, the IFFT/CP adding section 306 adds a CP to the signal in the time domain that the signal in the frequency domain is converted into.

The DAC 308 converts the data signal (digital signal) processed by the IFFT/CP adding section 306 into an analog signal. The DAC 308 provides the antenna 320 with the analog signal that the radio signal is converted into.

The antenna 320 transmits and receives radio signals to and from the respective remote stations 200.

The ADC 338 converts a radio signal received by the antenna 320 into a digital signal. The ADC 338 provides the FFT/CP removing section 336 with the digital signal (data signal) that the radio signal is converted into.

The FFT/CP removing section 336 removes the CP from the data signal that the radio signal is converted into by the ADC 338. The FFT/CP removing section 336 performs an FFT operation on the data signal remaining after the CP is removed so as to convert the data signal in the time domain into a signal in the frequency domain.

The de-mapping section 334 converts a signal received from the FFT/CP removing section 336 into a signal before being mapped based on a schedule (data of frequency band allotments) that the de-mapping section 334 is notified of by the scheduling section 310.

The demodulating section 332 demodulates and processes the signal that the signal received from the FFT/CP removing section 336 is converted into by the de-mapping section 334. The demodulating section 332 sends a received signal to the upper rank. Further, the demodulating section 332 provides the received signal quality measuring section 340 with the received signal.

The received signal quality measuring section 340 measures received signal quality in each of the frequency ranges in accordance with a received power level of a reference signal included in a signal transmitted by the control station and an interference level coming from another cell. The received signal quality measuring section 340 transmits a sub-band CQI carried by a control signal on the uplink to the control station 100 based on a result of the measurement. The received signal quality measuring section 340 may calculate a reference signal received power (RSRP) level and an RSRQ level, i.e., a ratio of the RSRP to the value of the total received power from the received signal, etc.

The control station 100 and the remote station 200 may be each implemented by the use of an exclusive or general purpose computer or an electronic apparatus on which a computer is installed. The terminal 300 may be implemented by the use of an exclusive or general purpose computer such as a smartphone, a mobile phone or an automotive navigation system or an electronic apparatus on which a computer is installed.

A computer, i.e., a data processing device includes a processor, a primary storage device, a secondary storage device and a device which interfaces with a peripheral device such as a communication interface device. The storage devices (primary and secondary storage devices) are each a computer-readable recording medium.

The processor loads a program stored in the recording medium into a work area in the primary storage device and runs the program, and the peripheral device is controlled as the program is run, so that the computer may achieve a function which agrees with a specific purpose.

The processor, e.g., is a central processing unit (CPU) or a digital signal processor (DSP). The primary storage device includes, e.g., a random access memory (RAM) or a read only memory (ROM).

The secondary storage device, e.g., is an erasable programmable ROM (EPROM) or a hard disk drive (HDD). Further, the secondary storage device may include a removable medium, i.e., a portable recording medium. The removable medium is a Universal Serial Bus (USB) memory or a disk-type recording medium such as a compact disc (CD) or a digital versatile disc (DVD).

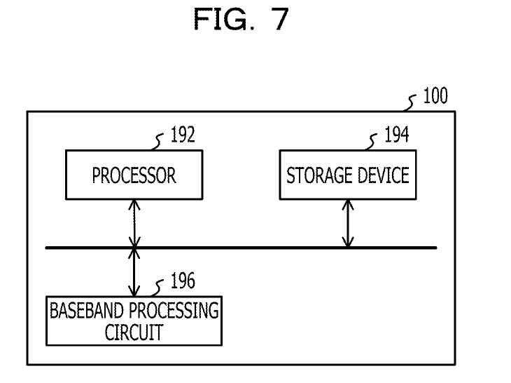

FIG. 7 illustrates an exemplary hardware configuration of the control station. The control station 100 includes a processor 192, a storage device 194 and a baseband processing circuit 196. The processor 192, the storage device 194 and the baseband processing circuit 196 are connected with one another, e.g., via a bus.

The processor 192 may achieve functions of the scheduling section 110, the transmission power determining section 106 and the path loss estimating section 108.

A program to be run by the processor, data to be used when the program is run, etc., are stored in the storage device 194.

The baseband processing circuit 196 may achieve functions of the modulating section 102, the demodulating section 112, the mapping section 104 and the de-mapping section 114. The baseband processing circuit 196 processes a baseband signal.

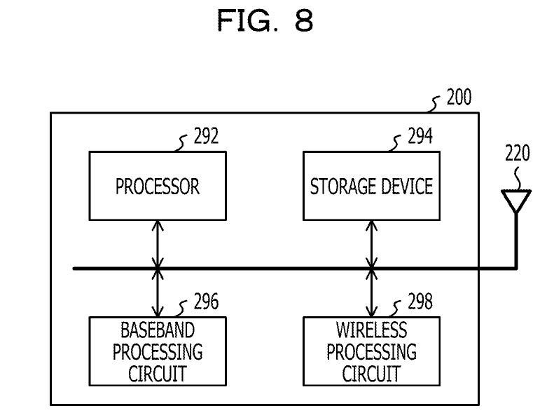

FIG. 8 illustrates an exemplary hardware configuration of the remote station. The remote station 200 includes a processor 292, a storage device 294, a baseband processing circuit 296, a wireless processing circuit 298 and an antenna 220. The processor 292, the storage device 294, the baseband processing circuit 296, the wireless processing circuit 298 and the antenna 220 are connected with one another, e.g., via a bus.

The processor 292 may achieve a function of the transmission power adjusting section 202.

A program to be run by the processor, data to be used when the program is run, etc., are stored in the storage device 294.

The baseband processing circuit 296 may process a signal as the IFFT/CP adding section 204 and the FFT/CP removing section 214.

The wireless processing circuit 298 may process a signal as the DAC 206 and the ADC 216. The wireless processing circuit 298 processes a wireless signal transmitted and received through the antenna 220.

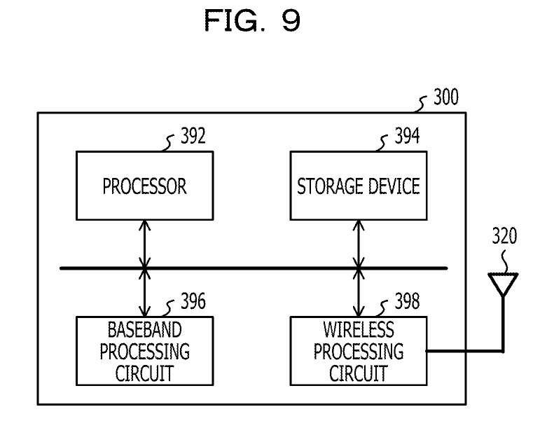

FIG. 9 illustrates an exemplary hardware configuration of the terminal. The terminal 300 includes a processor 392, a storage device 394, a baseband processing circuit 396, a wireless processing circuit 398 and an antenna 320. The wireless processing circuit 398 is connected to the antenna 320. The processor 392, the storage device 394, the baseband processing circuit 396 and the wireless processing circuit 398 are connected with one another, e.g., via a bus.

The processor 392 may achieve functions of the scheduling section 310 and the received signal quality measuring section 340.

A program to be run by the processor, data to be used when the program is run, etc., are stored in the storage device 394.

The baseband processing circuit 396 may process a signal as the modulating section 302, the demodulating section 332, the mapping section 304, the de-mapping section 334, the IFFT/CP adding section 306 and the FFT/CP removing section 336.

The wireless processing circuit 398 may process a signal as the DAC 308 and the ADC 338.

(Exemplary Operation)

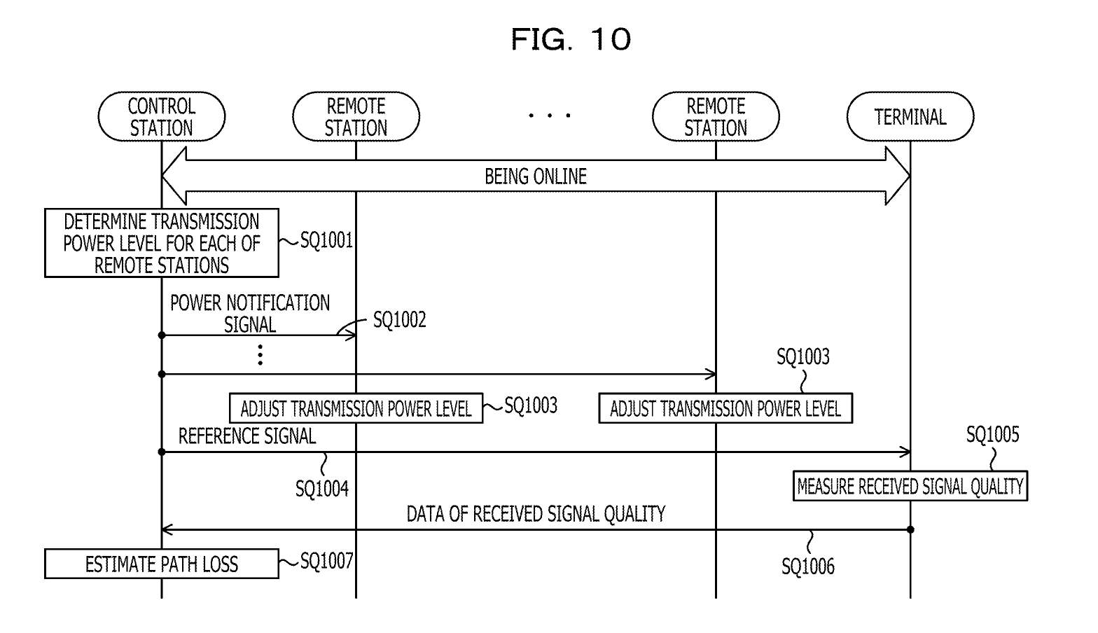

FIG. 10 illustrates an exemplary operational sequence of the system of the embodiment. The system of the embodiment estimates a path loss value between the remote station 200 and the terminal 300.

Suppose that a communication link has been established between the control station 100 and the terminal 300. The control station 100 and the terminal 300 transmit and receive signals to and from each other via the remote station 200. An operational sequence following SQ1001 illustrated in FIG. 10 is run, e.g., at regular intervals.

The transmission power determining section 106 of the control station 100 determines a transmission power level for each of the remote stations 200 in each of the frequency ranges (SQ1001). The transmission power level is determined as explained later.

The transmission power determining section 106 of the control station 100 transmits the determined transmission power levels as a power notification signal to the respective remote stations 200 (SQ1002). The power notification signal includes the transmission power levels for the respective remote stations 200 in the respective frequency ranges. Further, the power notification signal may be generated individually for each of the remote stations, and may be transmitted individually to each of the remote stations.

The transmission power adjusting section 202 of each of the remote stations 200 obtains the transmission power level of the remote station in each of the frequency ranges from the power notification signal that the remote station is notified of by the control station 100. The remote stations 200 each adjust the transmission power in each of the frequency ranges on the basis of the received transmission power level (SQ1003).

The control station 100 transmits signals including a reference signal to the terminal 300 (SQ1004). The remote station 200 transmits the signals including the reference signal transmitted by the control station 100 and with the power adjusted on SQ1003. The terminal 300 receives the signals including the reference signal transmitted from the respective remote stations 200.

The received signal quality measuring section 340 of the terminal 300 measures received signal quality in each of the frequency ranges from power of the received reference signal, received power of interference, etc (SQ1005).

The terminal 300 transmits data of received signal quality indicating the measured received signal quality to the control station 100 (SQ1006).

The path loss estimating section 108 calculates a path loss value (or a channel gain) between each of the remote stations 200 and the terminal 300 on the basis of the transmission power level of each of the remote stations 200 in each of the frequency ranges and the received signal quality in each of the frequency ranges received from the terminal 300 (SQ1007).

The operation following SQ1001 may be started, e.g., if a workload measured on the control station 100 is not larger than a particular value.

The path loss value is calculated as explained later.

(Calculate Path Loss Value)

The path loss estimating section 108 of the control station 100 estimates a path loss value between each of the remote stations and the terminal by using the transmission power level in each of the frequency ranges that the remote stations 200 are each notified of and the received signal quality on the terminal 300 in each of the frequency ranges.

The relationship among the channel gain G, the transmission power level P of each of the remote stations 200 in each of the frequency ranges and the received signal quality C on the terminal 300 is indicated below. The channel gain is the inverse of the path loss value.

$$C = \frac{1}{σ} PG$$

In the above equation, the variable σ indicates a power level of interference coming from another cell and noise. Suppose, for the embodiment, that the variable σ is fixed without depending on time or frequencies.

The received signal quality C on the terminal 300 is indicated below.

$$C = ( \begin{matrix}{γ}_{1} \\ {γ}_{2} \\ ⋮ \\ {γ}_{n}\end{matrix} )$$

In the above equation, the variable γᵢ indicates received signal quality on the terminal 300 in the frequency range #i. If the power P transmitted by the respective remote stations 200 is fixed for a particular period of time, the variable γᵢ may indicate an average of the received signal quality on the terminal 300 in the frequency range #i for the particular period of time. The integer n indicates the number of the frequency ranges that the remote stations 200 use. The received signal quality is periodically transmitted from the terminal 300 to the control station 100 as the sub-band CQI.

The transmission power levels of the respective remote stations 200 are indicated as a following matrix P.

$$P = ( \begin{matrix}{p}_{1 , 1} & {p}_{1 , 2} & … & {p}_{1 , m} \\ {p}_{2 , 1} & {p}_{2 , 2} & & \\ & & ⋱ & ⋮ \\ {p}_{n , 1} & & … & {p}_{n , m}\end{matrix} )$$

Each of the elements in the above matrix p_{i,j} indicates a transmission power level of a remote station 200#j in the frequency range #i. The integer m indicates the number of the remote stations 200. Suppose that the integer m is principally the number of remote stations 200 which are working. A remote station 200 which is not working (without transmitting a radio wave) is excluded from the matrix P.

The channel gain G is indicated below.

$$G = ( \begin{matrix}{g}_{1} \\ {g}_{2} \\ ⋮ \\ {g}_{m}\end{matrix} )$$

In the above equation, the variable gⱼ is the channel gain derived from the remote station 200#j. The channel gain is the inverse of the path loss value. That is, the path loss value between the terminal 300 and the remote station 200#j is 1/gⱼ.

The channel gain G is calculated as indicated below.

G=σP⁻¹C (n=m)

G=σ(P^{T}P)⁻¹P^{T}C (n>m)

The elements of the matrix P are each a coefficient included in simultaneous equations which define relationships between the respective elements of the matrix C and the respective elements of the channel gain G. If the number of nonzero eigenvalues is equal to or larger than m in the matrix P, the simultaneous equations resultantly include m− and over independent equations and the channel gain G may be calculated. Further, if the matrix P is not a square matrix and the number of nonzero eigenvalues is equal to or larger than m in a matrix P^{T}P, the simultaneous equations resultantly include m− and over independent equations and the channel gain G may be calculated.

The variable σ is calculated, e.g., as indicated below.

$$RSRQ = \frac{RSRP}{RSRP - σ}$$

$$σ = \frac{RSRP}{RSRQ} - RSRP$$

The term RSRP stands for “reference signal received power” and the term reference signal received quality (RSRQ) is a ratio of the reference signal received power to the total received power. The variable σ is not limited to the above example. The terms RSRP and RSRQ each represent feedback data transmitted from the terminal 300 to the control station 100 via the remote stations 200.

The path loss gain is calculated as the inverse of the channel gain.

(Determine Transmission Power Level)

The transmission power determining section 106 of the control station 100 determines a transmission power level for each of the remote stations 200 in each of the frequency ranges.

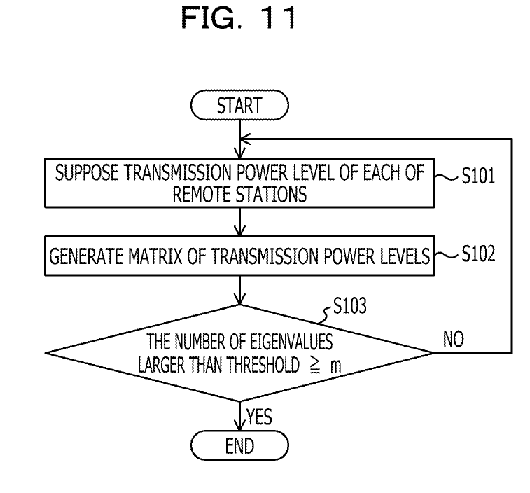

FIG. 11 illustrates an exemplary operational flow for determining a transmission power level by the transmission power determining section 106 in the control station 100.

The transmission power determining section 106 supposes a transmission power level for each of the remote stations 200 in each of the frequency ranges (S101). The transmission power determining section 106 generates a transmission power level P (in a matrix form) for each of the remote stations 200 in each of the frequency ranges, and calculates an eigenvalue of the matrix P (S102).

The transmission power determining section 106 decides whether the number of eigenvalues of the matrix P which is equal to or larger than a certain fixed value (threshold) is equal to or larger than the number of the remote stations 200 (S103). Suppose that an eigenvalue which is smaller than the certain fixed value is zero. If the number of eigenvalues of the matrix P which is equal to or larger than the certain fixed value is smaller than the number m of the remote stations 200 (S103: NO), the process returns to the step S101.

If the number of eigenvalues of the matrix P which is equal to or larger than the certain fixed value is equal to or larger than the number m of the remote stations 200 (S103: YES), the process ends. At this time, the matrix P finally generated at the step S102 is determined as the matrix of the transmission power levels of the respective remote stations 200 in the respective frequency ranges.

If the number of nonzero eigenvalues is smaller than the number m of remote stations in the matrix P, it is impractical to calculate the channel gain G. If the number of nonzero eigenvalues is equal to or larger than the number of remote stations m in the matrix P, the channel gain G may be calculated. Thus, the transmission power determining section 106 tries to generate the matrix P until the number of eigenvalues which is equal to or larger than the certain fixed value of the matrix P amounts to the number m of the remote stations 200. If the number of nonzero eigenvalues of the matrix P is equal to or larger than m, the number of independent equations amounts to m and the channel gain G may be calculated.

Quality of a signal received from one of the remote stations 200 depends upon the total of the transmission power levels of the relevant remote station 200. Suppose that the total of the transmission power levels is a particular value for each of the remote stations 200 at the step S101. Then, the received signal quality on the terminal 300 is not worse than it is in a case where the transmission power level is fixed regardless of the frequency ranges and the total of the transmission power levels is the relevant particular value.

If the matrix P is not a square matrix, the matrix P^{T}P is used instead of the matrix P after the matrix P is generated in the operational flow illustrated in FIG. 11. At the step S102, e.g., an eigenvalue of the matrix P^{T}P which is a square matrix is calculated.

### Effect of the Embodiment

The transmission power determining section 106 of the control station 100 determines transmission power levels for the respective remote stations 200 in the respective frequency ranges (frequencies). The transmission power levels determined for the respective remote stations 200 in the respective frequency ranges are a group of transmission power levels. The transmission power determining section 106 changes transmission power of a signal provided by the remote station 200 in a direction of frequencies. The path loss estimating section 108 of the control station 100 calculates a path loss value (on the downlink) between each of the remote stations 200 and the terminal 300 on the basis of the transmission power levels determined for the respective remote stations 200 in each of the frequency ranges and the received signal quality in each of the frequency ranges received from the terminal 300. The received signal quality in each of the frequency ranges is a group of data of received signal quality.

According to the configuration of the embodiment, it is enabled to estimate the path loss value between the remote station 200 and the terminal 300 on the uplink without separating a user on each of links between the respective remote stations 200 and the terminal 300. According to the configuration of the embodiment, further, it is enabled to estimate the path loss value between the remote station 200 and the terminal 300 on the downlink without transmitting an identification number specific to the remote station. According to the configuration of the embodiment, further, it is enabled to estimate the path loss value between the remote station 200 and the terminal 300 without separating the received signal into signal components of the respective remote stations 200 or stopping each of the remote stations 200 from transmitting a signal in some frequency range.

Since the remote station 200 of the embodiment is provided with the IFFT/CP adding section 204, the remote station 200 is enabled to adjust transmission power to a transmission power level in each of the frequency ranges.

The control station 100 may calculate a path loss value between each of the remote stations 200 and the terminal 300 by using the feedback data transmitted by the terminal 300. The terminal 300 is provided without a specific structure to calculate the path loss value.

The control station 100 may reduce power, e.g., transmitted from the remote station 200 to the terminal 300 with a large path loss value by using the path loss value, so that interference to affect another cell may be reduced. A large path loss value suggests a long distance between the terminal 300 and the remote station 200. At this time, a signal transmitted from the remote station 200 to the terminal 300 makes no contribution to enhancement of the received signal quality on the terminal 300, and what is worse, may possibly cause more interference for another cell. Thus, the control station 100 may adjust the power transmitted from the remote station 200 to the terminal 300 so as to reduce interference caused for another cell. That is, the control station 100 may set smaller transmission power to a remote station 200 of a large path loss value with a view to a certain terminal 300, and set larger transmission power to a remote station 200 of a small path loss value, so that the terminal 300 may receive a signal with enhanced quality.

### Second Embodiment

A second embodiment will be explained. The first and second embodiments have some configuration in common which will be omitted to be explained, and differences will be primarily explained.

(Exemplary Configuration)

A system of the embodiment includes a control station 600, a plurality of remote stations 700 and a terminal 800, and is constituted similarly to the exemplary system configuration illustrated in FIG. 2.

The system of the embodiment is to estimate a path loss value between each of the remote stations 700 and the terminal 800. The control station 600 of the embodiment changes transmission power of a signal provided by the remote station 700 in a direction of time.

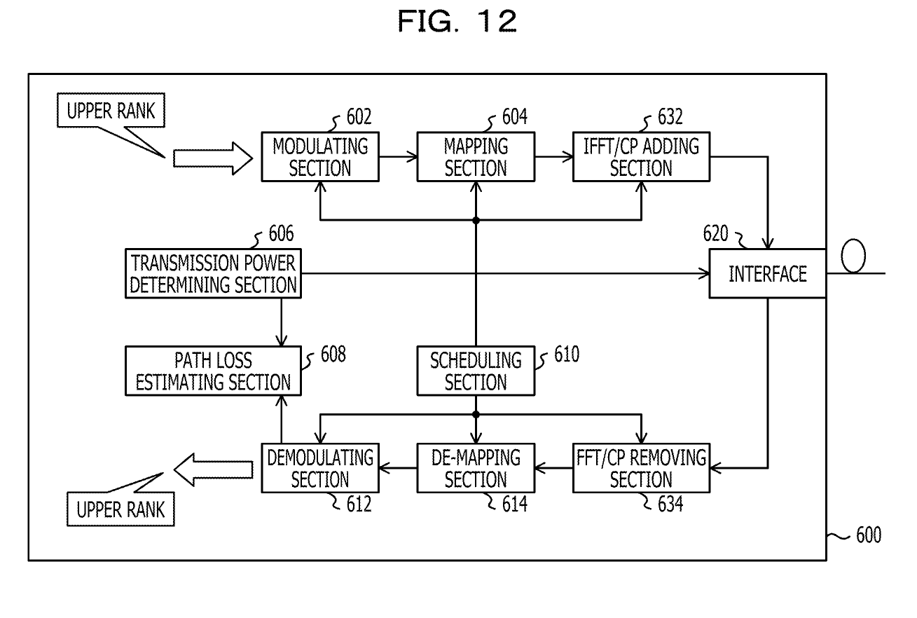

FIG. 12 illustrates exemplary functional blocks of the control station. The control station 600 includes a modulating section 602, a mapping section 604, a transmission power determining section 606, a path loss estimating section 608, a scheduling section 610, a demodulating section 612 and a de-mapping section 614. The control station 600 further includes an IFFT/CP adding section 632 and an FFT/CP adding section 634.

The IFFT/CP adding section 632 performs an IFFT operation on a signal mapped by the mapping section 604 and converts the signal in the frequency domain into a signal in the time domain. Further, the IFFT/CP adding section 632 adds a CP to the signal in the time domain that the signal in the frequency domain is converted into. The IFFT/CP adding section 632 outputs the processed signal to the remote station 700 via an interface 620.

The FFT/CP removing section 634 removes a CP from a data signal that an input to an ADC 716 of the remote station 700 is converted into. The FFT/CP removing section 634 performs an FFT operation on the data signal remaining after the CP is removed so as to convert the data signal in the time domain into a signal in the frequency domain. The FFT/CP removing section 634 provides the de-mapping section 614 with the processed signal.

The transmission power determining section 606 determines how many times the transmission power is changed, which equals how many times the terminal 800 measures received signal quality before the path loss value is calculated. The number of times the transmission power is changed is larger than the number of the remote stations 700. If the number of times the transmission power is changed is smaller than the number of the remote stations 700, it is impractical to calculate the path loss value. The transmission power determining section 606 determines a transmission power level for each of the remote stations 700 each time the transmission power is changed (transmission power pattern). The transmission power determining section 606 determines a transmission power such that the transmission power level remains fixed in the direction of frequencies for each of the remote stations 700 differently from the corresponding portion of the first embodiment. The transmission power is resultantly changed on one of the remote stations 700 each time the transmission power is changed based on the transmission power pattern. If the transmission power is changed at regular intervals, the transmission power is changed based on the transmission power pattern at regular intervals.

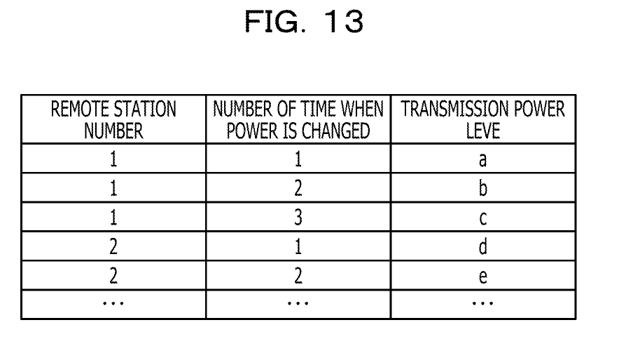

FIG. 13 illustrates exemplary transmission power levels of the respective remote stations on respective occasions when the power is changed that the remote stations are each notified of. The transmission power determining section 606 determines a transmission power level for each of the remote stations each time the transmission power is changed as illustrated in FIG. 13, and notifies the respective remote stations 700 of what is determined. FIG. 13 illustrates a table which corresponds to a matrix P described later.

The path loss estimating section 608 estimates a path loss value between each of the remote stations and the terminal by using the transmission power level determined each time the transmission power is changed that the remote stations 700 are each notified of and an average of received signal quality in the full frequency range measured each time the transmission power is changed on the terminal 800. The path loss estimating section 608 receives the transmission power level that the remote stations 700 are each notified of by the transmission power determining section 606. The path loss estimating section 608 receives received signal quality in each of the frequency ranges on the terminal 800 from the demodulating section 612.

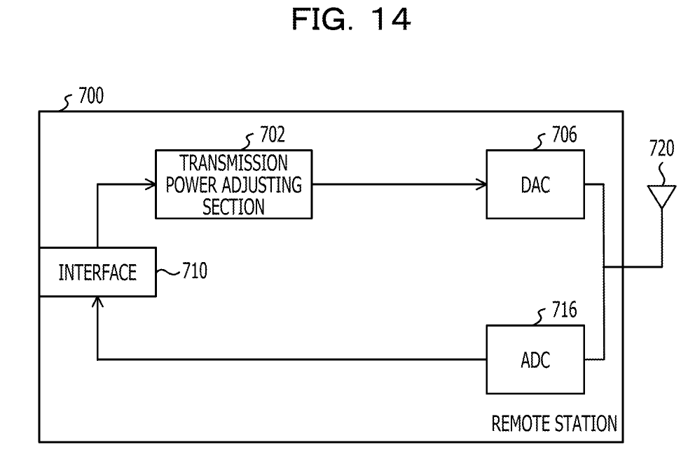

FIG. 14 illustrates exemplary functional blocks in the remote station. The remote station 700 includes a transmission power adjusting section 702, a DAC 706, an interface 710, an ADC 716 and an antenna 720.

The transmission power adjusting section 702 obtains a transmission power level of the remote station determined each time the transmission power is changed from the transmission power levels of the respective remote stations 700 on the respective occasions when the power is changed that the remote stations are each notified of by the control station 600. The transmission power adjusting section 702 adjusts a transmission power level of a transmission signal each time the transmission power is changed based on the transmission power level determined each time the transmission power is changed. The intervals at which the transmission power is changed is, e.g., same as the intervals at which the received signal quality is measured on the terminal 800.

The DAC 706 converts a data signal (digital signal) whose transmission power is changed by the transmission power adjusting section 702 into an analog signal. The DAC 706 provides the antenna 720 with the analog signal that the data signal is converted into.

The ADC 716 converts a radio signal received by the antenna 720 into a digital signal. The ADC 716 provides the control station 600 with the digital signal (data signal) that the radio signal is converted into.

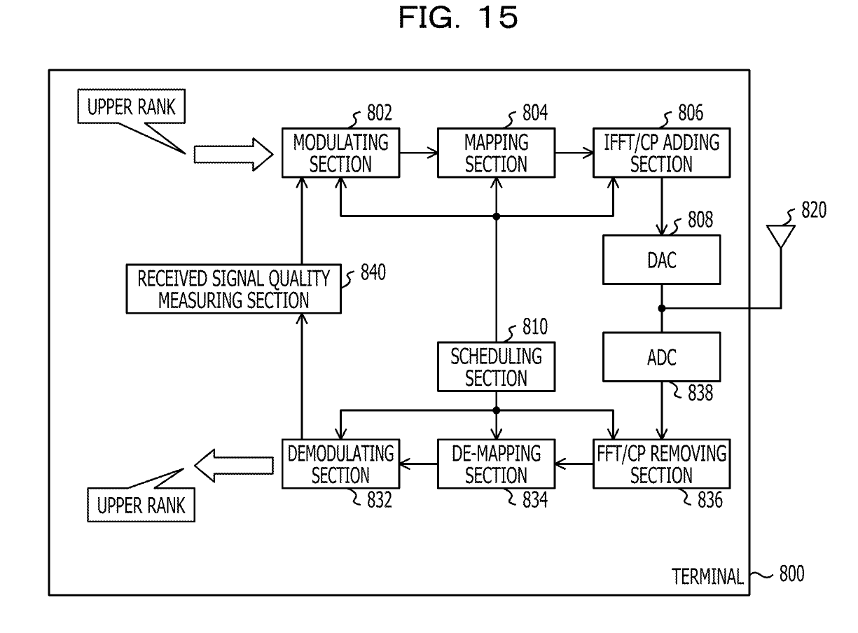

FIG. 15 illustrates exemplary functional blocks in the terminal. The terminal 800 includes a modulating section 802, a mapping section 804, an IFFT/CP adding section 806, a DAC 808, a scheduling section 810, an antenna 820, a demodulating section 832, a de-mapping section 834, an FFT/CP removing section 836, an ADC 838 and a received signal quality measuring section 840.

The terminal 800 measures an average of received signal quality in the whole frequency range in accordance with a received power level of a reference signal that the control station 600 transmits via the remote station 700 and an interference power level coming from another cell. The terminal 800 transmits a wideband Channel Quality Indicator (CQI) carried by a control signal on the uplink to the control station 600 on the basis of resultantly measured received signal quality. The wideband CQI is a signal indicating a quantized average of the received signal quality in the whole frequency range. The wideband CQI is a kind of feedback data. The terminal 800 periodically (at regular intervals) transmits the wideband CQI to the control station 600. The wideband CQI indicates an average of the received signal quality in the whole frequency range.

The received signal quality measuring section 840 measures an average of received signal quality in the whole frequency range in accordance with a received power level of a reference signal included in a signal transmitted by the control station and an interference level coming from another cell at least each time the power is changed. The received signal quality measuring section 840 transmits a wideband CQI carried by a control signal on the uplink to the control station 600 on the basis of a result of the measurement at least each time the power is changed. The received signal quality measuring section 840 calculates a reference signal received power (RSRP) level and an RSRQ level, i.e., a ratio of the RSRP to a level of total received power. The received signal quality measuring section 840 may collectively transmit the values of the received signal quality on all occasions when the power is changed to the control station 600.

The control station 600, the remote station 700 and the terminal 800 may be implemented according to hardware configurations similar to those illustrated in FIGS. 7, 8 and 9, respectively.

(Exemplary Operation)

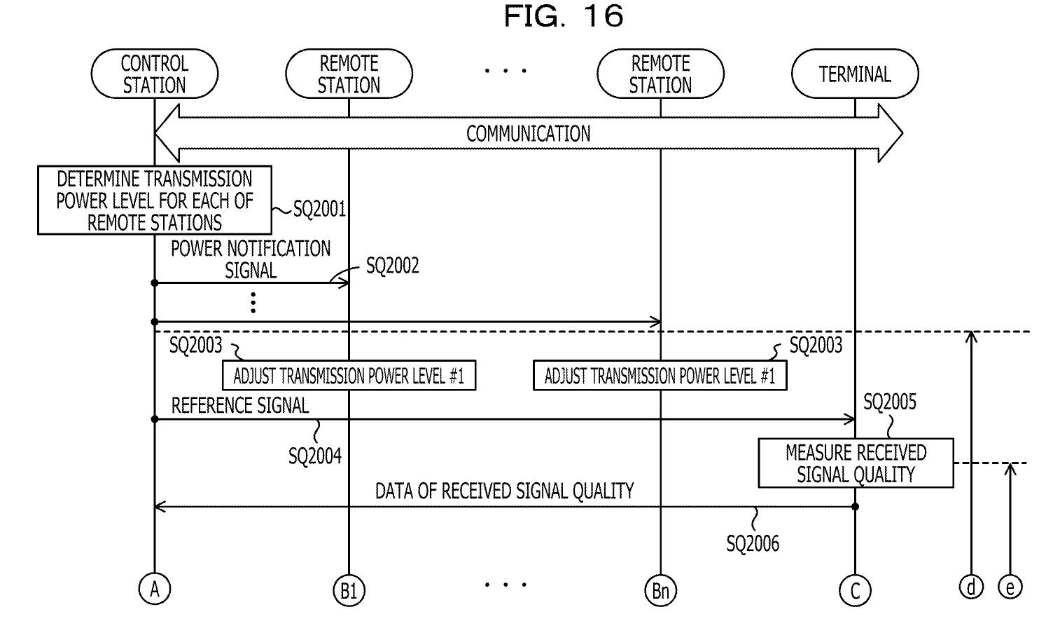

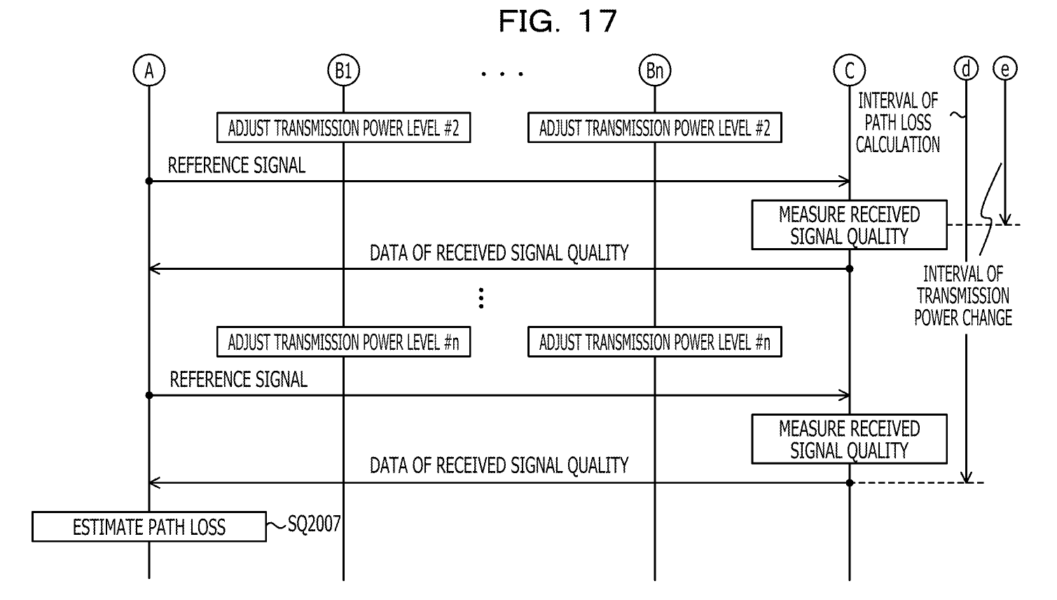

FIGS. 16 and 17 illustrate an exemplary operational sequence of the system of the embodiment. Symbols “A”, “B1”-“Bn”, “C”, “d” and “e” illustrated in FIG. 16 interface with symbols “A”, “B1”-“Bn”, “C”, “d” and “e” illustrated in FIG. 17, respectively.

The system of the embodiment estimates a path loss value between the remote station 700 and the terminal 800.

Suppose that a communication link has been established between the control station 600 and the terminal 800. The control station 600 and the terminal 800 transmit and receive signals to and from each other via the remote station 700.

The transmission power determining section 606 of the control station 600 determines a transmission power level for each of the remote stations 700 each time the transmission power is changed (SQ2001). The transmission power level is determined as explained later.

The transmission power determining section 606 of the control station 600 transmits the determined transmission power levels as a power notification signal to the respective remote stations 700 (SQ2002).

The transmission power adjusting section 702 of each of the remote stations 700 obtains the transmission power level of the remote station, determined each time the transmission power is changed, from the power notification signal that the remote station is notified of by the control station 600. The remote stations 700 each adjust the transmission power each time the transmission power is changed on the basis of the received transmission power level (SQ2003).

The control station 600 transmits signals including a reference signal to the terminal 800 (SQ2004). The remote station 700 transmits the signals including the reference signal transmitted by the control station 600 and with the power adjusted on SQ2003. The terminal 800 receives the signals including the reference signal transmitted from the respective remote stations 700.

The received signal quality measuring section 840 of the terminal 800 measures an average of the received signal quality in the whole frequency range from power of the received reference signal, received power of interference, etc (SQ2005).

The terminal 800 transmits data of received signal quality indicating the measured received signal quality to the control station 600 (SQ2006).

The control station 600, the respective remote stations 700 and the terminal 800 repeat the process of SQ2003 through SQ2006 as many times as the transmission power is changed as determined by the transmission power determining section 606 (n-times in this case).

The path loss estimating section 608 receives the received signal quality measured as many times as the transmission power is changed as determined by the transmission power determining section 606. The path loss estimating section 608 obtains a transmission power level of each of the remote stations 700 determined each time the transmission power is changed from the transmission power determining section 606. The path loss estimating section 608 calculates a path loss value (or a channel gain) between each of the remote stations 700 and the terminal 800 on the basis of the transmission power level of each of the remote stations 700 determined each time the transmission power is changed and the received signal quality measured each time the transmission power is changed received from the terminal 800 (SQ2007).

The path loss value is calculated as explained later.

(Calculate Path Loss Value)

The path loss estimating section 608 in the control station 600 estimates an individual path loss value between each of the remote stations and the terminal by using the transmission power level determined each time the transmission power is changed that the remote stations 700 are each notified of and the received signal quality on the terminal 800 measured each time the transmission power is changed.

The relationship among the channel gain G, the transmission power level P for each of the remote stations 700 determined each time the transmission power is changed and the received signal quality C on the terminal 800 is indicated below. The channel gain is the inverse of the path loss value.

$$C = \frac{1}{σ} PG$$

In the above equation, the variable σ indicates a power level of interference coming from another cell and noise. Suppose, for the embodiment, that the variable σ is fixed without depending on time or frequencies.

The received signal quality C on the terminal 800 is indicated below.

$$C = ( \begin{matrix}{γ}_{1} \\ {γ}_{2} \\ ⋮ \\ {γ}_{n}\end{matrix} )$$

In the above equation, the variable γᵢ indicates an average of the received signal quality in the whole frequency range at #i-th time when the transmission power is changed on the terminal 800. The integer n is the number of times the transmission power is changed as determined by the transmission power determining section 606. Suppose that the integer n is equal to or larger than the number of the remote stations 700. The received signal quality is periodically transmitted from the terminal 800 to the control station 600 as the wideband CQI.

The transmission power levels of the respective remote stations 600 are indicated as a following matrix P.

$$P = ( \begin{matrix}{p}_{1 , 1} & {p}_{1 , 2} & … & {p}_{1 , m} \\ {p}_{2 , 1} & {p}_{2 , 2} & & \\ & & ⋱ & ⋮ \\ {p}_{n , 1} & & … & {p}_{n , m}\end{matrix} )$$

Each of the elements in the above matrix, p_{i,j} indicates a transmission power level of a remote station 700#j at #i-th time at which the transmission power is changed. The integer m indicates the number of the remote stations 700. Suppose that the integer m is principally the number of remote stations 700 which are working. A remote station 700 which is not working (without transmitting a radio wave) is excluded from the matrix P.

The channel gain G is indicated below.

$$G = ( \begin{matrix}{g}_{1} \\ {g}_{2} \\ ⋮ \\ {g}_{m}\end{matrix} )$$

In the above equation, the variable gᵢ is the channel gain derived from the remote station 700#j. The channel gain is the inverse of the path loss value. That is, the path loss value between the terminal 800 and the remote station 700#j is 1/gᵢ.

The channel gain G is calculated as indicated below.

G=σP⁻¹C (n=m)

G=σ(P^{T}P)⁻¹P^{T}C (n>m)

The elements of the matrix P are each a coefficient in included in simultaneous equations which define relationships between the respective elements of the matrix C and the respective elements of the channel gain G. If the number of nonzero eigenvalues is equal to or larger than m in the matrix P, the simultaneous equations resultantly include m− and over independent equations and the channel gain G may be calculated. Further, if the matrix P is not a square matrix and the number of nonzero eigenvalues is equal to or larger than m in a matrix P^{T}P, the simultaneous equations resultantly include m− and over independent equations and the channel gain G may be calculated. The variable σ is calculated, e.g., as indicated below.

$$RSRQ = \frac{RSRP}{RSRP - σ}$$

$$σ = \frac{RSRP}{RSRQ} - RSRP$$

The term RSRP stands for “reference signal received power” and the term reference signal received quality (RSRQ) is a ratio of the reference signal received power to the total received power. The variable σ is not limited to the above example. The terms RSRP and RSRQ each represent feedback data transmitted from the terminal 800 to the control station 600 via the remote stations 700.

The path loss value is calculated as the inverse of the channel gain.

(Determine Transmission Power Level)

The transmission power determining section 606 of the control station 600 determines a transmission power level for each of the remote stations 700 each time the power is changed.

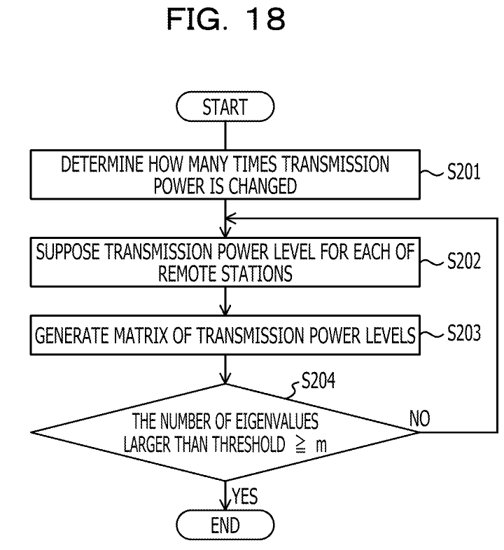

FIG. 18 illustrates an exemplary operational flow for determining the transmission power level by the transmission power determining section 606 of the control station 600.

The transmission power determining section 606 determines how many times the transmission power is changed (S201), which equals how many times the terminal 800 measures received signal quality before the path loss value is calculated. The number of times the transmission power is changed may be preset time for path loss calculation (time to be taken before the path loss value is calculated) divided by one of the intervals at which the received signal quality is measured on the terminal 800. The number of times the transmission power is changed is a natural number. The intervals at which the received signal quality is measured are, e.g., preset to the terminal 800. Further, the number of times the transmission power is changed may be the time for path loss calculation divided by one of the intervals at which the received signal quality is measured on the terminal 800 multiplied by an integer n. The transmission power determining section 606 supposes a transmission power level for each of the remote stations 700 each time the power is changed (S202). The transmission power determining section 606 generates a transmission power level P (in a matrix form) for each of the remote stations 700 each time the power is changed, and calculates an eigenvalue of the matrix P (S203).

The transmission power determining section 606 decides whether the number of eigenvalues of the matrix P which is equal to or larger than a certain fixed value (threshold) is equal to or larger than the number of the remote stations 700 (S204). Suppose that an eigenvalue which is smaller than the certain fixed value is zero. If the number of eigenvalues of the matrix P which is equal to or larger than the certain fixed value is smaller than the number m of the remote stations 700 (S204: NO), the process returns to the step S202.

If the number of eigenvalues of the matrix P which is equal to or larger than the certain fixed value is equal to or larger than the number m of the remote stations 700 (S204: YES), the process ends. At this time, the matrix P finally generated at the step S203 is determined as the matrix of the transmission power levels of the respective remote stations 700 on the respective occasions that the transmission power is changed.

If the number of nonzero eigenvalues is smaller than the number m of remote stations in the matrix P, it is impractical to calculate the channel gain G. If the number of nonzero eigenvalues is equal to or larger than the number of remote stations m in the matrix P, the channel gain G may be calculated. Thus, the transmission power determining section 606 tries to generate the matrix P until the number of eigenvalues which is equal to or larger than the certain fixed value of the matrix P amounts to the number m of the remote stations 700.

Suppose that the total of the transmission power levels is a particular value for each of the remote stations 700 at the step S202. Then, the signal transmitted by the remote station 700 is not worse than it is in a case where the transmission power level is fixed regardless of the frequency ranges and the total of the transmission power levels is the particular value.

If the matrix P is not a square matrix, the matrix P^{T}P is used instead of the matrix P after the matrix P is generated in the operational flow illustrated in FIG. 18. The matrix P^{T}P is a square matrix.

### Effect of the Embodiment

The control station 600 determines transmission power levels to be set at regular intervals for the respective remote stations. The transmission power levels to be set at regular intervals for the respective remote stations are a group of transmission power levels. The control station 600 does not determine a transmission power level on the remote station 700 as a transmission power level in each of frequency ranges. The transmission power level on the remote station 700 does not depend on a frequency range. Thus, the remote station 700 may adjust a transmission power level on a transmission signal having experienced an IFFT operation on the basis of the transmission power pattern determined by the control station 600. Thus, the remote station 700 may be provided without including the IFFT/CP adding section and the FFT/CP removing section. The configuration of the remote station 700 may thereby be simplified.

Further, the control station 600 changes the number of times the power is changed to any number so that the path loss value may be made more accurate or less accurate. If the power is changed more times, the number of elements in the matrix P increases so that the path loss value is expected to be more accurate.

### Third Embodiment

A third embodiment will be explained. The first to third embodiments have some configuration in common which will be omitted to be explained, and a difference will be primarily explained.

(Exemplary Configuration)

A system of the embodiment includes a control station, a plurality of remote stations and a terminal, and is constituted similarly to the exemplary system configuration illustrated in FIG. 2.

The system of the embodiment is to estimate a path loss value between each of the remote stations and the terminal. The control station of the embodiment changes transmission power of a signal provided by the remote station in directions of frequencies and time.

The control and remote stations and the terminal of the embodiment are constituted similarly as the control station 100, the remote station 200 and the terminal 300 of the first embodiment, respectively.

The transmission power determining section in the control station of the embodiment determines how many times the power is changed. Further, the transmission power determining section of the embodiment determines a transmission power level for each of the remote stations each time the power is changed in each of the frequency ranges (transmission power pattern).

The transmission power adjusting section in the remote station of the embodiment extracts a transmission power level for the remote station, determined each time the power is changed in each of the frequency ranges, from the transmission power levels determined for the respective remote stations on the respective occasions when the power is changed in the respective frequency ranges that the remote stations are each notified of by the control station. The transmission power adjusting section adjusts a transmission power level of a transmission signal on the basis of the transmission power level determined each time the power is changed in each of the frequency ranges.

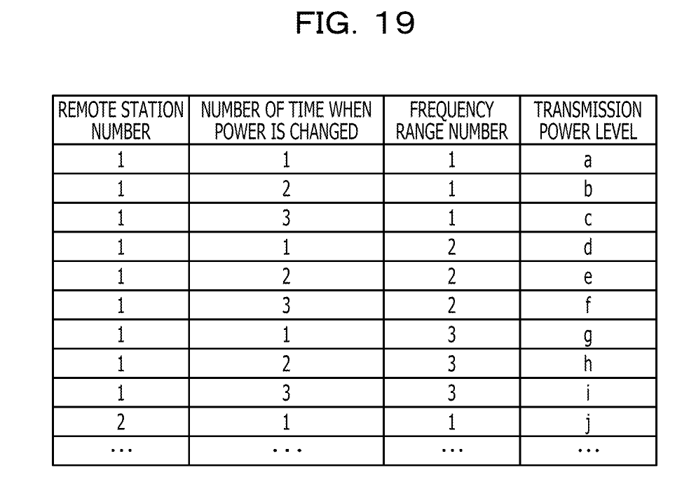

FIG. 19 illustrates exemplary transmission power levels of the respective remote stations on the respective occasions when the power is changed in the respective frequency ranges that the remote stations are each notified of. The transmission power determining section determines a transmission power level for each of the remote stations each time the power is changed in each of the frequency ranges as illustrated in FIG. 19, and notifies each of the remote stations of what is determined. The table illustrated in FIG. 19 corresponds to a matrix P described later.

The received signal quality measuring section in the terminal of the embodiment measures received signal quality in each of the frequency ranges in accordance with a received power level of a reference signal included in a signal transmitted by the control station and an interference level coming from another cell. The received signal quality measuring section transmits a sub-band Channel Quality Indicator (CQI) carried by a control signal on the uplink to the control station on the basis of a result of the measurement. The received signal quality measuring section calculates a reference signal received power (RSRP) level and an RSRQ level, i.e., a ratio of the RSRP to the level of the total received power.

The control station, the remote station and the terminal of the embodiment may be implemented according to hardware configurations similar to those illustrated in FIGS. 7, 8 and 9, respectively.

(Exemplary Operation)

The embodiment achieves an operational sequence similar to that of the second embodiment illustrated in FIGS. 16 and 17. The operational sequence of the embodiment differs from that of the second embodiment mainly in that the transmission power level is adjusted on the remote station in each of the frequency ranges.

(Calculate Path Loss Value)

The path loss estimating section in the control station estimates a path loss value between each of the remote stations and the terminal by using the transmission power level determined each time the transmission power is changed in each of the frequency ranges that the remote stations are each notified of and the received signal quality on the terminal measured each time the transmission power is changed in each of the frequency ranges.

The relationship among the channel gain G, the transmission power level P for each of the remote stations determined each time the transmission power is changed in each of the frequency ranges and the received signal quality C on the terminal is indicated below. The channel gain is the inverse of the path loss value.

$$C = \frac{1}{σ} PG$$

In the above equation, the variable σ indicates a power level of interference coming from another cell and noise. Suppose, for the embodiment, that the variable σ is fixed without depending on time or frequencies.

The received signal quality C on the terminal is indicated below.

$$C = ( \begin{matrix}{C}_{1} \\ {C}_{2} \\ ⋮ \\ {C}_{{N}_{t}}\end{matrix} )$$

In the above equation, an integer Nt is the number of times the transmission power is changed. An element Ct of the received signal quality C is indicated below.

$${C}_{t} = ( \begin{matrix}{γ}_{1 , t} \\ {γ}_{2 , t} \\ ⋮ \\ {γ}_{{N}_{f} , t}\end{matrix} )$$

In the above equation, the variable γ_{i,k} indicates received signal quality at #k-th time when the transmission power is changed in the frequency range #i on the terminal. The integer Nf is the number of the frequency ranges that each of the remote stations uses.

Further, the transmission power levels P of the respective remote stations are indicated below.

$$P = ( \begin{matrix}{P}_{1} \\ {P}_{2} \\ ⋮ \\ {P}_{{N}_{t}}\end{matrix} )$$

The element Pt of the transmission power P is indicated below.

$${P}_{t} = ( \begin{matrix}{p}_{1 , 1 , t} & {p}_{1 , 2 , t} & … & {p}_{1 , {N}_{rrh} , t} \\ {p}_{2 , 1 , t} & {p}_{2 , 2 , t} & & \\ ⋮ & & ⋱ & ⋮ \\ {p}_{{N}_{f} , 1 , t} & & … & {p}_{{N}_{f} , {N}_{rrh} , t}\end{matrix} )$$

In the above equation, the element p_{i,j,k} is a transmission power level on the remote station #j in the frequency range #i at the #k-th time when the power is changed. The integer Nrrh is the number of the remote stations, and is principally the number of remote stations which are working. A remote station which is not working (without transmitting a radio wave) is excluded from the matrix P.

The channel gain G is indicated below.

$$G = ( \begin{matrix}{g}_{1} \\ {g}_{2} \\ ⋮ \\ {g}_{Nrrh}\end{matrix} )$$

In the above equation, the variable gⱼ is the channel gain between the remote station #j and the terminal. The channel gain is the inverse of the path loss value. That is, the path loss value between the terminal and the remote station #j is 1/gⱼ.

The channel gain G is calculated as indicated below.

G=σP⁻¹C (Nf×Nt=Nrrh)

G=σ(P^{T}P)⁻¹P^{T}C (Nf×Nt>Nrrh)

The elements of the matrix P are each a coefficient included in simultaneous equations which define relationships between the respective elements of the matrix C and the respective elements of the channel gain G. If the number of nonzero eigenvalues is equal to or larger than Nrrh in the matrix P, the simultaneous equations resultantly include Nrrh− and over independent equations and the channel gain G may be calculated. Further, if the matrix P is not a square matrix and the number of nonzero eigenvalues is equal to or larger than Nrrh in the matrix P^{T}P, the simultaneous equations resultantly include Nrrh− and over independent equations and the channel gain G may be calculated.

### Effect of the Embodiment

The control station of the embodiment changes transmission power of a signal provided by the remote station in the directions of frequencies and time. As the number of elements of the matrix P in the configuration of the embodiment is larger than that in the configuration of the other embodiments, the path loss value may be more precisely calculated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control station connected with a plurality of remote stations, the control station being configured to communicate with a terminal via the plural remote stations, the control station comprising:
a memory; and
a processor that, when executing a procedure stored in the memory, upon each of the plural remote stations transmitting same data to the terminal according to a transmission power pattern in which transmission power varies in a direction of frequencies or time,
receives a group of data of received signal quality that is based on power received by the terminal at frequency or time intervals, and
calculates a path loss value for each of the plural remote stations on the basis of a group of transmission power levels at frequency or time intervals for each of the plural remote stations and the group of data of received signal quality received from the terminal.

2. The control station according to claim 1, wherein the processor determines the group of transmission power levels for each of the plural remote stations such that the group of transmission power levels for each of the plural remote stations form a plurality of coefficients in simultaneous equations which define a relationship between the group of data of received signal quality and the path loss value for each of the plural remote stations, and that the number of independent equations included in the simultaneous equations is equal to or larger than the number of the path loss values.

3. The control station according to claim 1, wherein the processor determines the group of transmission power levels for each of the remote stations in each of frequency bands that the remote stations use, and calculates a path loss value for each of the remote stations on the basis of the group of received signal quality and the group of transmission power levels in each of the frequency bands.

4. The control station according to claim 1, wherein the processor determines the group of transmission power levels such that the transmission power levels varying according to the frequency bands amount to a particular level in all.

5. The control station according to claim 1, wherein the processor determines the transmission power level for each of the remote stations at regular intervals, and calculates the path loss value on the basis of the data of received signal quality at regular intervals and the transmission power level.

6. A remote station that is one of a plurality of remote stations connected with a control station which each relay communication between a terminal and the control station, the remote station comprising:
a processor configured to receive a signal transmitted from the control station to the terminal and adjust a transmission power level at frequency or time intervals so that the signal is transmitted to the terminal according to a transmission power pattern in which transmission power varies in a direction of frequencies or time;
a baseband processing circuit configured to perform an IFFT (Inverse Fast Fourier Transform) operation on the transmitted signal adjusted by the processor; and
a wireless processing circuit configured to transmit the transmitted signal processed by the baseband processing circuit to the terminal, wherein the transmission power pattern varies depending upon the plural remote stations.

7. A communication system comprising:
a plurality of remote stations; and
a control station configured to communicate with a terminal via the plural remote stations,
the plural remote stations each including
a wireless processing circuit configured to transmit data received from the control station to the terminal according to a transmission power pattern in which transmission power varies in a direction of frequencies or time,
the control station including
a processor configured to receive a group of data of received signal quality that is based on power received by the terminal at frequency or time intervals, and calculate a path loss value for each of the plural remote stations on the basis of a group of transmission power levels at frequency or time intervals for each of the plural remote stations and the group of data of received signal quality received from the terminal.

8. A communication method employed in a communication system including a plurality of remote stations and a control station configured to communicate with a terminal via the plural remote stations, the method comprising:
transmitting, by each of the remote stations, data received from the control station to the terminal according to a transmission power pattern in which transmission power varies in a direction of frequencies or time;
receiving, by the control station, a group of data of received signal quality that is based on power received by the terminal at frequency or time intervals from the terminal; and
calculating, by the control station, a path loss value for each of the plural remote stations on the basis of a group of transmission power levels at frequency or time intervals for each of the plural remote stations and the group of data of received signal quality received from the terminal.

9. The communication method according to claim 8, wherein the group of transmission power levels is determined for each of the plural remote stations such that the group of transmission power levels for each of the plural remote stations form a plurality of coefficients in simultaneous equations which define a relationship between the group of data of received signal quality and the path loss value for each of the plural remote stations, and that the number of independent equations included in the simultaneous equations is equal to or larger than the number of the path loss values.

10. The communication method according to claim 8, wherein the group of transmission power levels is determined for each of the remote stations in each of frequency bands that the remote stations use, and wherein a path loss value is calculated for each of the remote stations on the basis of the group of received signal quality and the group of transmission power levels in each of the frequency bands.

11. The communication method according to claim 8, wherein the group of transmission power levels is determined such that the transmission power levels varying according to the frequency bands amount to a particular value in all.

12. The communication method according to claim 8, wherein the transmission power level is determined for each of the remote stations at regular intervals, and wherein the path loss value is calculated on the basis of the data of received signal quality at regular intervals and the transmission power level.
